(19) United States
(12) Patent Application Publication
(10) Pub. No.: US 2018/0304417 A1
(43) Pub. Date: Oct. 25, 2018

(54) MOUNTING APPARATUS AND METHOD FOR CUTTING STEEL RULE DIE BOARDS

(71) Applicant: Simply KWK, LLC, Jerome, MI (US)

(72) Inventor: Kevin W. Koelsch, Jerome, MI (US)

(21) Appl. No.: 15/492,271

(22) Filed: Apr. 20, 2017

(51) Int. Cl. B23K 37/04; B26F 1/44; B23K 26/38

(52) U.S. Cl. CPC B23K 37/0426; B26F 1/44; B23K 2203/36; B26F 2001/4463; B23K 26/38

(57) ABSTRACT

An apparatus and method for mounting a steel rule cutting die board facilitates laser cutting of the kerfs in the die board. An elongate frame supports a plurality of various size partitions having surfaces sized to receive die boards of various radii. A plurality of axially spaced apart metal collars each includes lugs which are complementary to clamping members in a laser die cutting machine, a plurality of radially oriented flat plates having accurately positioned outer edges which engage and locate the die board, and a plurality of brackets, at least two of which are proximate the ends of the die board, which hold and position screws which engage the inside surface of the die board to secure it to the metal collars. The outer edges of the metal collars, between the flat plates, define surfaces obliquely oriented to lines of radius. These outer edges include consumable and replaceable protective covers.

### FIELD

The present disclosure relates to steel rule cutting dies and more particularly to an apparatus and method for mounting a steel rule cutting die board to facilitate laser cutting of the kerfs in the die board.

### BACKGROUND

The statements in this section merely provide background information related to the present disclosure and may or may not constitute prior art.

Steel rule cutting dies are a mainstay of the paperboard and cardboard packaging industry. The curved cutting dies, which define a fixed radius, include a plurality of perforating and cutting steel rules which weaken or sever corresponding locations of paperboard or cardboard stock. The cutting die is mounted to one of a pair of parallel rolls of a rotary press. The other of the pair of rolls is an anvil which the steel rules engage to achieve the perforating or cutting of the product as it passes between the rolls.

Clearly, the accuracy of the product is a direct consequence of the accurate preparation of the steel rule cutting die. The cutting die board, which is typically a precisely curved plywood panel, is prepared by securing the curved panel to a plurality of axially spaced apart wooden support structures disposed on the inside surface of the panel with wood screws installed from the outside of the panel. The curved plywood panel is then mounted in a machine similar to an X-Y plotter which moves the panel under a laser to cut kerfs for the steel rule dies.

Because there are only certain locations where screws can be located to attach to the support structures, a first significant difficulty of this process is the possibility of locating a wood screw directly on a laser cut kerf. This occurrence has several undesirable consequences. First of all, the laser will be unable to achieve a smooth, uniform cut at this location. Second of all, the screw may be damaged by the laser such that it will be difficult to remove. Lastly, the presence of a screw assumes a support structure on the inside or underside of the panel. Thus, not only may the attaching screw be damaged by the laser but also the supporting structure may be burned, become unusable and require replacement.

As an alternative, an attempt may be made to positively ensure that no attachment location coincides with a cutting die kerf and thus laser activity. This approach generally necessitates a time consuming layout on the panel of all the cutting die kerfs followed by arranging and often rearranging the support structures and screw locations to avoid the die kerfs and thus the laser. Due to the time involved, this approach has generally proved unsatisfactory.

From the foregoing, it is apparent that the present method of mounting steel rule die boards with screws to support structures for laser cutting has several shortcomings. The present invention is intended to reduce them and provide an improved mounting system for the production of laser cut steel rule cutting die boards.

### SUMMARY

The present invention provides an apparatus and method for mounting a steel rule cutting die board to facilitate laser cutting of the kerfs in the die board prior to insertion of the steel rule cutting and perforating dies. An elongate frame receives and supports a plurality of saddle partitions having inserts sized to receive and support die boards of various radii. The mounting apparatus also includes a plurality of axially spaced apart metal plates or collars which are secured to the curved inside surface of the die board by captive screws extending from brackets secured to the plate or collar. Generally alternating with the brackets and screws are a plurality of axially oriented stand-off plates or ribs also secured to the metal collar having accurately positioned outer edges which engage and locate the inner surface of the curved die board. The outer edges of the metal collars, between the flat plates and brackets, define surfaces obliquely oriented to lines of radius. These outer edges include consumable and replaceable protective covers. Proximate the center of the plate or collar are projecting lugs which are complementary to and engaged by clamping members on a rotary laser die cutting machine. A method of preparing a die board with the foregoing apparatus for laser cutting of steel rule kerfs is also disclosed.

Thus it is an aspect of the present invention to provide an improved mounting apparatus for laser cutting a steel rule die board.

It is a further aspect of the present invention to provide a mounting apparatus for laser cutting a steel rule die board having an elongate frame and a plurality of saddle partitions for receiving various sizes of die boards.

It is a still further aspect of the present invention to provide a mounting apparatus for laser cutting a steel rule die board having a plurality of axially spaced apart metal plates or collars.

It is a still further aspect of the present invention to provide a mounting apparatus for laser cutting a steel rule die board having a plurality of axially spaced apart metal plates or collars including a plurality of axially oriented stand-off plates or ribs secured to the metal collars.

It is a still further aspect of the present invention to provide a mounting apparatus for laser cutting a steel rule die board having a plurality of axially spaced apart metal plates or collars including axially oriented stand-off plates or ribs secured to the metal collars wherein outer edges of the metal collars, between the flat plates, define surfaces obliquely oriented to lines of radius.

It is a still further aspect of the present invention to provide a mounting apparatus for laser cutting a steel rule die board having a plurality of axially spaced apart metal collars including a plurality of brackets which hold and radially position screws which engage the inside surface of the die board to secure it to the metal collars.

It is a still further aspect of the present invention to provide a method for preparing a steel rule die board for laser cutting of kerfs utilizing an elongate frame and a plurality of axially spaced apart metal plates or collars.

Further aspects, advantages and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a frame according to the present invention which receives a plurality of saddle partitions which support a die board or panel during installation of internal collars;

FIG. 2A is an end view of the frame according to the present invention having a large, an intermediate and a small size saddle partition installed therein;

FIG. 2B is an enlarged, fragmentary view of a portion of a large and an intermediate saddle partition according to the present invention;

FIG. 3 is a perspective view of the frame with three largest saddle partitions having three intermediate saddle partitions installed therein, a curved die board clamped in the intermediate saddle partitions and three attachment plates or collars secured to the inside of the die board or panel;

FIG. 4 is an enlarged side view of an attachment plate or collar disposed on the inside of a curved die board or panel;

FIG. 5 is a fragmentary, sectional view of a stand-off plate or rib taken along line 5-5 of FIG. 4; and

FIG. 6 is a fragmentary, sectional view of a spring loaded attachment screw assembly taken along line 6-6 of FIG. 4.

### DETAILED DESCRIPTION

The following description is merely exemplary in nature and is not intended to limit the present disclosure, application, or uses.

At the outset, it should be understood that both maintaining the necessary and desired radius of curvature of the wood, typically plywood, die board or panel and accurate laser cutting of kerfs in the die board which receive the steel rule cutting or perforating dies is critical to acceptable performance of the completed steel rule cutting die. Accordingly, it will be appreciated that many of the features and steps of the following description are directed to highly accurate positioning and mounting of the die board or panel which, in turn, ensures (1) establishment and maintenance of the design radius of the die board, (2) accurate mounting on the laser die cutting machine, (3) accurate laser cutting of the kerfs in the die board, (4) accurate placement of the steel rule cutting dies in the die board, and (5), most importantly, accurate product cutting and perforation.

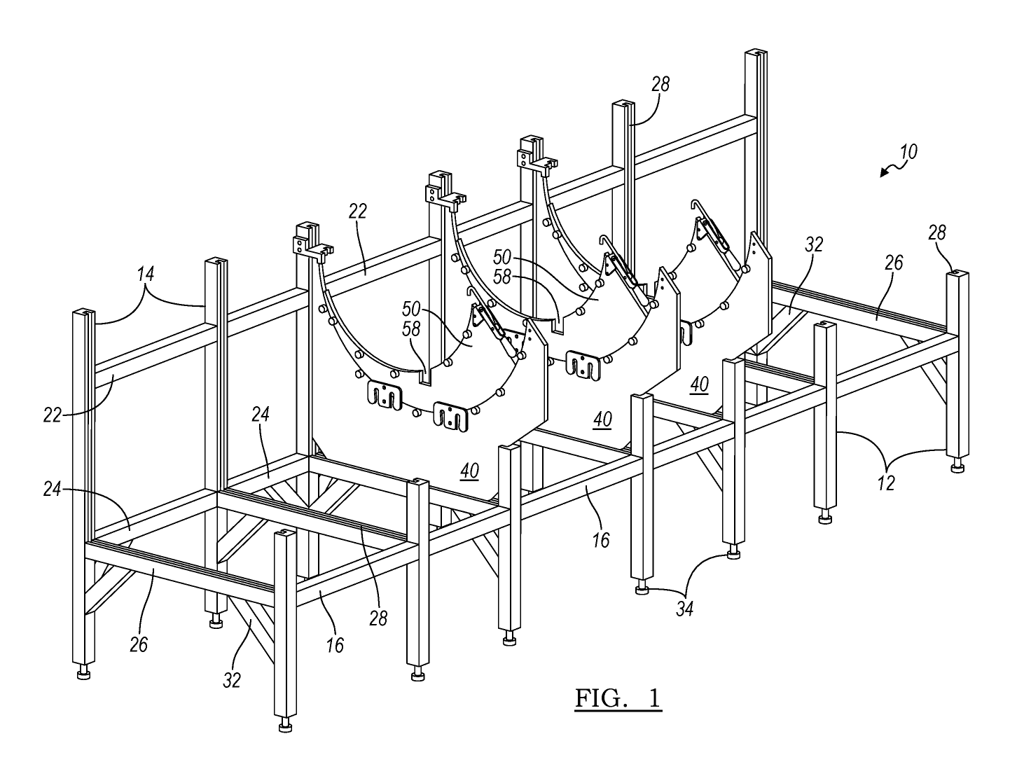

With reference to FIG. 1, an elongate frame which receives a plurality of saddle partitions is illustrated and generally designated by the reference number 10. The elongate frame 10 includes a plurality of front upright members or posts 12 and a like plurality of aligned, taller, rear upright members or posts 14. Note that preferably, though not necessarily, the longitudinal spacing between the upright members 12 and 14 is not equal. Rather, the upright members 12 and 14 are spaced unequally and duplicate the spacing of mounting features in certain laser die cutting machines. The front upright members 12 are connected by a plurality of longitudinal front braces 16 and, similarly, the rear upright members 14 are connected by upper and lower pairs of longitudinal rear braces 22 and 24. Extending between the front upright members 12 and the rear upright members 14 and co-planar with the front braces 16 and the lower rear braces 24 are a plurality of transverse braces 26. The inner faces of the front upright members 12 and the rear upright members 14 above the transverse braces 26 and the upper faces of the transverse braces 26 include a channel or groove 28 which facilitates mounting of components on the frame 10 as will be explained directly below. Triangular reinforcing gussets 32 may be installed at various locations between the upright members 12 and 14, the transverse braces 26 and the lower rear braces 24 to strengthen the frame 10. If desired, adjustable levelling feet 34 may be installed at the lower ends of the front upright members 12 and the rear upright members 14 to ensure that the frame 10 is square, plumb and stable on uneven floors.

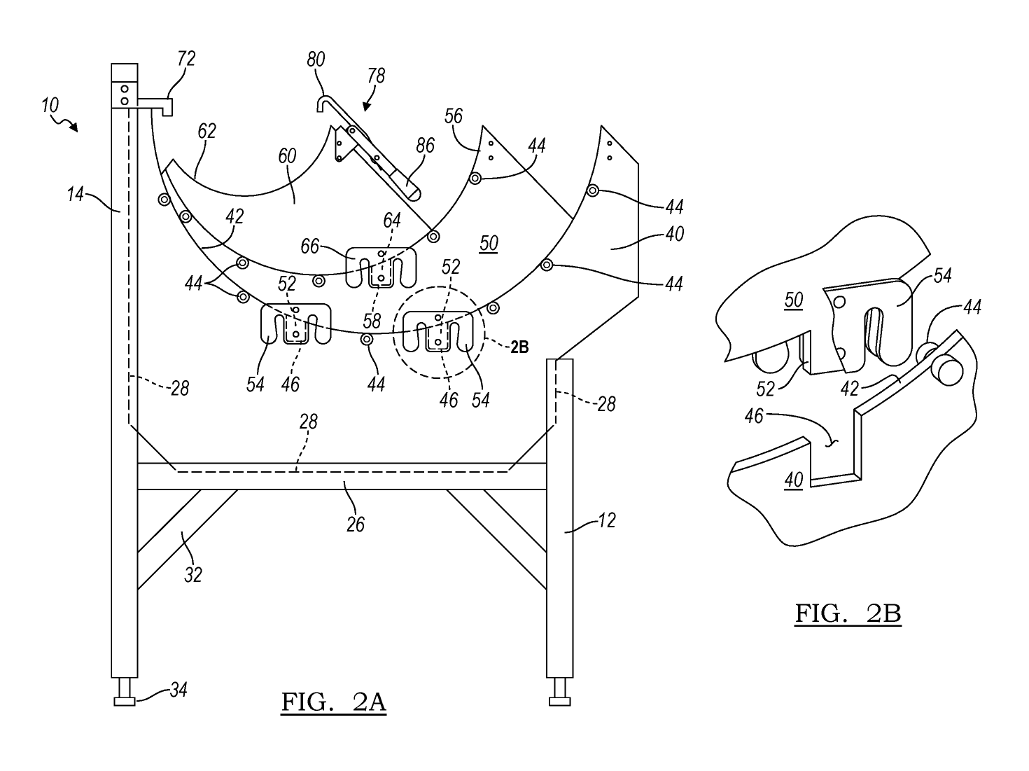

Referring now to FIGS. 1, 2A and 2B, it should be understood that due to various sizes of product and packaging, there is a corresponding variation in the size of rotary die boards, panels or shells. Such variation has, however, been essentially standardized and the present invention is complementary to and fully functional with such standardized sizes. This is accomplished by the utilization of a plurality of partitions that stack or seat within the frame 10 or larger partitions to accommodate several, smaller sizes of die boards or shells. Specifically, the radius of the largest, routinely used die board is 26.50 inches (67.31 cm.) and a largest partition 40 defines a curved surface 42 substantially corresponding to this radius. The largest partition 40 is received within and seated in the channels or groves 28 of the uprights 12 and 14 and braces 26 of the frame 10. To facilitate and ensure accurate placement of the die board or shell in and on the partition 40, a plurality of pairs of roller bearing assemblies 44 are disposed on both faces or surfaces of the partition 40 adjacent and extending just slightly beyond the curved surface 42 such that the die board contacts, is positioned by and readily moves on the roller bearing assemblies 44.

The curved surface 42 of the partition 40 is interrupted by a pair of spaced apart notches or cut-outs 46 that, if a smaller size partition, such as a 19.18 inch (48.72 cm.) intermediate size partition 50 is utilized, receive a pair of complementarily spaced apart lugs or tabs 52 extending from the intermediate partition 50 that positively locate the intermediate partition 50 within the largest partition 40. Such positive location is further assisted by pairs of locating plates 54 on both faces or surfaces of the intermediate partition 50 covering and extending beyond the lugs or tabs 52. The intermediate partition 50 defines a curved surface 56, as noted above, of substantially 19.18 inches (48.72 cm.) and includes a plurality of pairs of roller bearing assemblies 44 which are disposed on both faces or surfaces of the partition 50 adjacent and extending just slightly beyond the curved surface 56 such that the die board contacts, is positioned by and readily moves on the roller bearing assemblies 44. The intermediate partition 50 also includes a single notch or cut-out 58

A third size partition (not illustrated) which is essentially the same as the intermediate partition 50 defines a radiused curve of substantially 14.00 inches (35.35 cm.), includes pairs of roller bearing assemblies 44 and is utilized with die boards, panels or shells of corresponding radii.

FIG. 2A also illustrates a fourth, smaller partition 60 having a radiused surface 62 of substantially 10.00 inches (25.4 cm.). Because of its small size and radius, the incorporation of ball bearing assemblies has been deemed unnecessary although they may included if desired or deemed beneficial. The smaller partition 60 does include a single lug or tab 64 which seats in the notch or cut-out 58 of the intermediate partition 50 as well as a single pair of locating plates 66 on both faces or surfaces of the smaller partition 60 covering and extending beyond the lug or tab 64. Thus it will be appreciated that the frame 10 effectively accepts saddle partitions defining a plurality of radii that correspond to common die board or shell radii, rendering the device essentially of universal application. In this regard, it should also be appreciated that saddle partitions having curved surfaces of radii other than those specifically recited above are considered to be, and are, within the scope and purview of this invention.

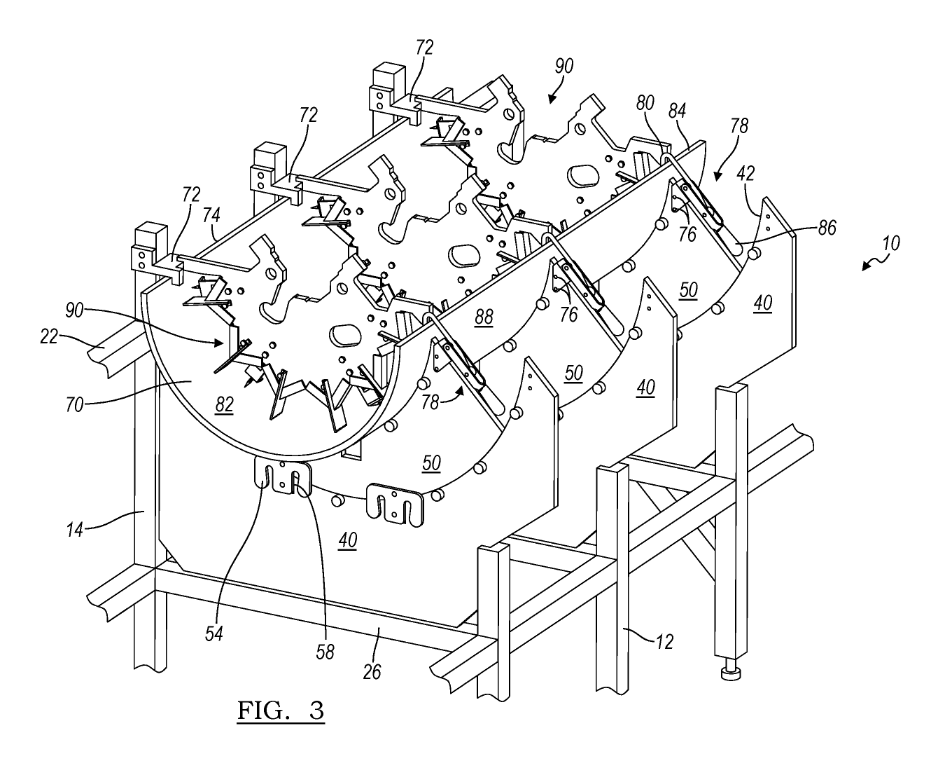

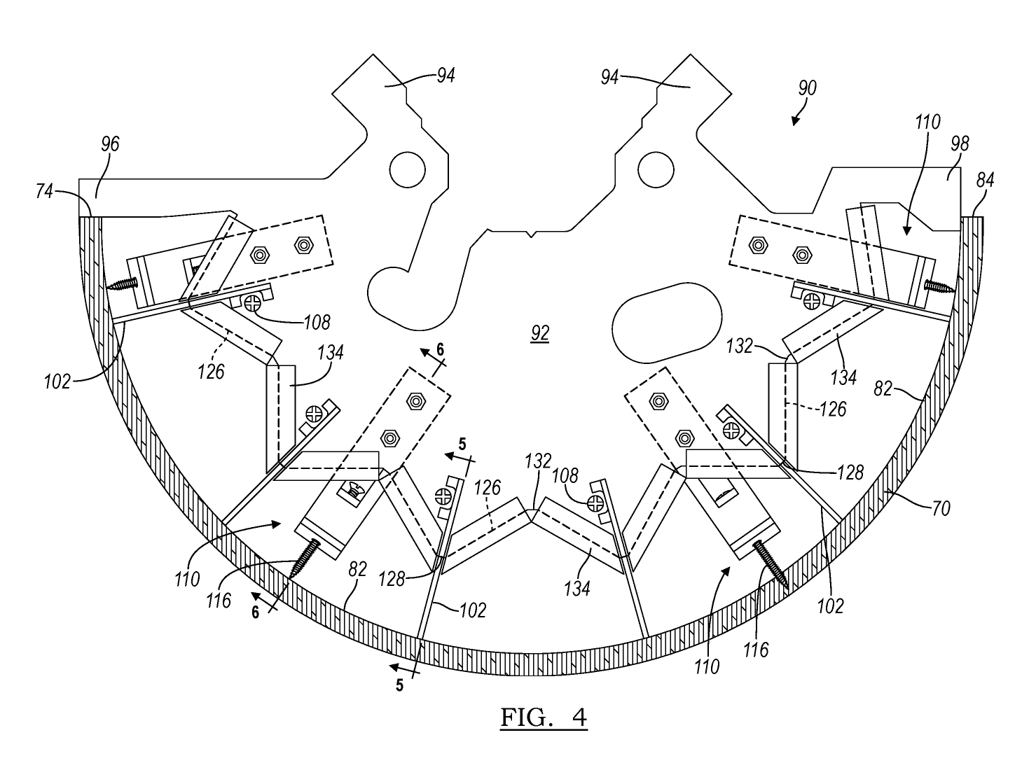

Referring now to FIGS. 3 and 4, a curved, that is, semi-cylindrical, die board, panel or shell 70 has been mounted in three spaced apart partition assemblies comprising the largest partition 40 having an effective radiused surface 42 of 26.5 inches on which is mounted an intermediate partition 50 having an effective radiused surface 56 of 19.18 inches. It should be appreciated that the curved, semi-cylindrical die board 70 is exemplary and representative of die boards in general which may and often will (1) define other radii, as described elsewhere in this document, and (2) extend circumferentially less than the nominal 180° of the die board 70 illustrated. Thus, the frame 10 is configured to, and does, accept a die board 70 having a nominal radius of 19.18 inches. Attached to the rear upright members 14, adjacent their upper ends, are limit stops or register blocks 72 against which the rear edge 74 of the die board 70 abuts when it is fully and properly seated within the intermediate partitions 50.

Secured to an upper portion of each of the intermediate partitions 50 adjacent the curved surface 56 by threaded fasteners 76 is a toggle clamp 78 having a hook or claw 80 that engages the inside surface 82 of the die board adjacent its front edge 84. The toggle clamps 78 include a lever 86 coupled in an over-center arrangement to the hook or claw 80. In conventional fashion, when the hook or claw 80 is engaged with the inside surface 82 of the die board 70 and the lever 86 is moved to the position illustrated in FIG. 3, the die board 70 is rotated into the position illustrated in FIG. 3, the rear edge 74 of the die board 70 abuts the limit stops or register blocks 72 and the outside surface 88 of the die board 70 is in intimate contact with the roller bearing assemblies 44 which effectively and substantially define the radius of 19.18 inches. As illustrated in FIG. 2A, the toggle clamps 78 are mounted adjacent the curved surface of whichever saddle partition is being utilized, in this instance, adjacent the curved surface 62 of the saddle partition 60.

These components and this action are important because they accurately establish and conform the radius of the outside surface 88 of the die board 70 to the desired nominal radius, in this case, 19.18 inches. The die board 70 is now in position for installation of a plurality of mounting plates or collars 90 as explained directly below. When the lever 86 is raised, clamping pressure on the die board 70 is released, the hooks or claws 80 may be released and the die board 70 may be removed from the intermediate partitions 50.

Each of the mounting plates or collars 90 defines a relatively substantial metal, preferably steel or aluminum alloy, body 92 having a thickness of approximately one-quarter to one-half an inch or more. Each mounting collar 90 is generally semi-circular and may include lugs or projections 94 and other features which are complementary to mounting components such as channels and clamps (not illustrated) in a rotary laser die cutting machine. The mounting collar 90 also includes a longer, first or register arm 96 of sufficient radial length such that an axial (straight) edge of the die board, such as the rear edge 74, may abut the register arm 96 when the mounting collar 90 is disposed in the die board 70. Radially opposite the register arm 96 is a shorter, second arm, locating tab or projection 98 that engages the inside surface 82 of the die board 70.

From the foregoing, it will be appreciated that each of the various sizes of die board 70 requires corresponding sizes of not only the saddle partitions 40, 50 and 60 but also the mounting plates or collars 90. Thus, as this text describes, preparation of a die board 70 having a nominal radius of 19.18 inches requires corresponding mounting collars or plates 90 configured for installation and use with a 19.18 inch die board; a 26.50 inch radius die board requires the saddle partitions 40 and mounting collars sized to fit within a 25.50 inch radius die board and so on.

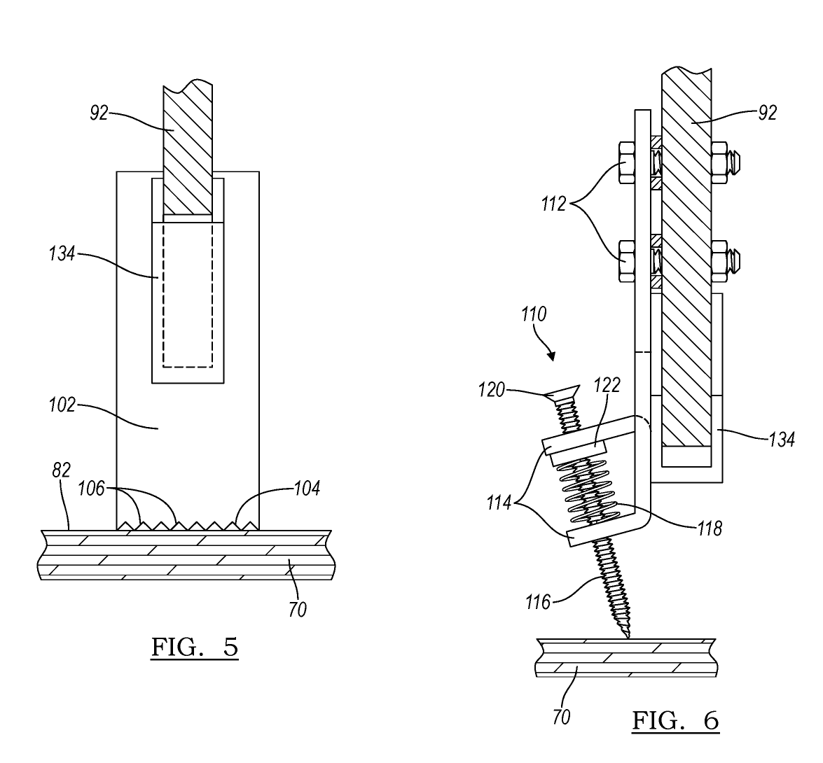

Referring now to FIGS. 4 and 5, radially extending from the body 92 of the mounting collar 90 are a plurality of circumferentially spaced apart stand-off flat plates or ribs 102. The outer ends of the stand-off ribs 102 preferably terminate in saw teeth 104 that contact and grip the inside surface 82 of the die board 70. The saw teeth 104 have oblique surfaces 106 which are exposed to the laser beam of the die board cutting machine. Because of their angular orientation to the laser beam, the oblique surfaces 106 deflect and disperse the beam rather than essentially absorbing it as a perpendicular end of the stand-off rib 102 would. Laser damage to the saw teeth 104 of the stand-off ribs 102 is thus minimized and their service life extended. The radial locations or positions of the stand-off ribs 102 (and the saw teeth 104) are adjustable by loosening a set screw 108, moving the ribs to the desired location and retightening the set screw 108. If desired, a semi-permanent resin adhesive (not illustrated) may be utilized to prevent loosening of the set screw 108 and movement of the stand-off rib 102. This adjustability is important because the positions of the saw teeth 104 of the stand-off ribs 102 establish the radius of the inside surface 82 of the die board 70.

Referring now to FIGS. 4 and 6, disposed proximate each straight edge, that is, proximate the rear edge 74 and the front edge 84 of the die board 70, as well as intermediate locations generally alternating with the stand-off ribs 102 on the body 92 of the mounting collar 90, are a plurality of mounting brackets 110. The mounting brackets 110 may be secured to the body 92 by any suitable fasteners such as machine bolts and nuts 112 and are generally “L” shaped with two spaced-apart, parallel feet 114. Extending between the spaced apart feet 114 is a captive, obliquely oriented fastener, such as a wood screw 116. The oblique (angled) orientation of the fastener 116 relative to the body 92 of the mounting collar 90 facilitates installation and removal. The fastener 116 is biased radially inwardly, away from the die board 70, to facilitate removal from the die board 70, by a compression spring 118. The fastener 116 has limited outward travel to prevent it from piercing or puncturing the die board 70. This outward travel limit is established by either the head 120 of the fastener 116 contacting the adjacent foot 114 of the mounting bracket or a washer 122 which translates with the fastener 116 compressing the compression spring 118 until it is solid.

Finally, the outer edge of the mounting plate or collar 90 includes alternating oblique surfaces 126 which are disposed at angles to lines of radius. The oblique surfaces 126 form peaks 128 at the locations of the stand-off ribs 102 and valleys 132 midway therebetween. Secured by a tight friction fit or an adhesive to the alternating oblique surfaces 126 are a plurality of “U”-shaped consumable or sacrificial metal shields or covers 134. Like the ends of the stand-off ribs 102, the outer edge of the mounting plate or collar 90 defined by the alternating oblique surfaces 126 is exposed to the laser beam and the obliquely disposed consumable shields 134 deflect and absorb it and may be replaced when pitted or damaged, thereby extending the service life of the mounting collar 90.

Thus it will be appreciated that according to the present invention a steel rule die board may be prepared for laser cutting of steel rule kerfs by selecting a set of appropriate sized saddle partitions, from, for example, the various sizes represented by the partitions 40, 50 and 60, installing them at suitable locations in an elongate frame 10, positioning the rear edge 74 of the die board 70 against the limit stops or register blocks 72 by engaging and closing the toggle clamps 78 and installing a plurality of correspondingly sizes mounting collars 90 on the inside surface 82 of the die board 70 by screwing the captive fasteners 114 into the die board 70.

The description of the invention is merely exemplary in nature and variations that do not depart from the gist of the invention are intended to be within the scope of the invention. Such variations are not to be regarded as a departure from the spirit and scope of the invention.

What is claimed is:

1. An apparatus for mounting a curved steel rule die board for laser cutting comprising, in combination,
an elongate frame having a plurality of spaced apart front and rear uprights, at least two saddle partitions disposed in said frame and having a curved upper surface, a plurality of bearings adjacent said curved surface for supporting the curved die board and a toggle clamp for engaging an edge of the die board, and
at least two mounting collars for disposition within the curved die board, said mounting collars having a plurality of stand-offs for engaging an inner surface of the curved die board and a plurality of brackets each carrying a captive fastener for threading into the curved die board and securing the curved die board to said mounting collar.

2. The apparatus of claim 1 wherein said saddle partitions include at least one notch in said curved surface.

3. The apparatus of claim 1 wherein said saddle partitions include a curved lower surface and at least one projection extending from said curved lower surface.

4. The apparatus of claim 1 wherein said bearings are ball bearing assemblies and are disposed in pairs on opposite faces of said saddle partition.

5. The apparatus of claim 1 wherein said plurality of stand-offs include an end having saw teeth engaging said inner surface of the curved die board.

6. The apparatus of claim 1 wherein an outer edge of said mounting collars defines a plurality of alternating oblique surfaces.

7. The apparatus of claim 1 further including a stop on said rear uprights for limiting movement of the curved die board.

8. The apparatus of claim 1 wherein said saddle partitions include at least one notch in said curved upper surface and a second, smaller saddle partition having a projection complementary to said notch is disposed on said curved upper surface of said saddle partition.

9. A mounting collar for a semi-cylindrical wood die board comprising, in combination,
a generally semi-circular metal body having a first register arm configured to engage an end edge of a die board and a second tab configured to engage an inside surface of such die board and mounting lugs between said register arm and said tab,
an edge extending between said register arm and said tab, said edge defining a plurality of alternating oblique surfaces defining peaks and valleys,
a plurality of radially oriented stand-offs extending from said peaks of said edge and having outer ends defining saw teeth, and
a plurality of brackets secured to said body and including threaded fasteners configured to engage such inside surface of such die board.

10. The mounting collar for a die board of claim 9 further including a plurality of shields disposed on said alternating oblique surfaces of said edge of said body.

11. The mounting collar for a die board of claim 9 further including second threaded fasteners for releasably securing said stand-offs to said body.

12. The mounting collar of claim 9 wherein said threaded fasteners are wood screws.

13. The mounting collar of claim 9 wherein said threaded fasteners are captive in said brackets.

14. The mounting collar of claim 9 wherein said threaded fasteners are obliquely oriented to said body of said mounting collar.

15. The mounting collar of claim 9 further including compression springs disposed about said threaded fasteners for biasing said fasteners away from such die board.

16. A method of preparing a die board for laser cutting of steel rule kerfs, comprising the steps of:
selecting a die board of a given radius,
providing a plurality of saddle partitions having a curved surface of the given radius,
installing said saddle partitions in spaced-apart relationship in a frame,
clamping said die board in said saddle partitions against said curved surface,
securing a plurality of metal mounting collars within said die board with threaded fasteners, and
unclamping said die board and removing said die board from said saddle partitions.

17. The method of claim 16 wherein said clamping is achieved by toggle clamps.

18. The method of claim 16 wherein said metal mounting collars are positioned within said die board by a plurality of ribs engaging an inner surface of said die board.
